(19) United States
(12) Patent Application Publication
(10) Pub. No.: US 2005/0213299 A1
(43) Pub. Date: Sep. 29, 2005

(54) Memory package

(76) Inventors: Thomas T. Hardt, Missouri City, TX (US); George D. Megason, Spring, TX (US); Kurt A. Manweiler, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/812,128

(22) Filed: Mar. 29, 2004

(51) Int. Cl. G06F 1/16

(52) U.S. Cl. 361/684

(57) ABSTRACT

A memory package comprising a first cover portion connected to a second cover portion. The first cover portion supports a first electronics sub-assembly that comprise a circuit board with at least one memory module socket and at least one controller chip mounted thereto. The second cover portion supports a second electronics sub-assembly that comprises a circuit board with at least one memory module socket and at least one controller chip mounted thereto. The first and second cover portions are moveable between a closed position wherein the electronics sub-assemblies are nested and an open position wherein the electronics sub-assemblies are not nested.

### BACKGROUND

Certain computer-based systems, for example servers, employ a variety of different components. Each of these components requires a certain volumetric envelope to operate in. Although the size of one individual component may be fairly small, many systems utilize multiple examples of each type of component. The multiple examples may be supplied to provide redundancy or to improve the operation of the system. For example, servers may use a plurality of memory modules that may be upgraded or replaced periodically. Therefore, a system that supports efficient storage of a plurality of memory modules while also supporting access to the memory modules for maintenance reasons may be advantageous.

### SUMMARY

A memory package comprising a first cover portion connected to a second cover portion. The first cover portion supports a first electronics sub-assembly that comprises a circuit board with at least one memory module socket and at least one controller chip mounted thereto. The second cover portion supports a second electronics sub-assembly that comprises a circuit board with at least one memory module socket and at least one controller chip mounted thereto. The first and second cover portions are moveable between a closed position wherein the electronics sub-assemblies are nested and an open position wherein the electronics sub-assemblies are not nested.

### BRIEF DESCRIPTION OF THE DRAWINGS

For a detailed description of certain embodiments of the invention, reference will now be made to the accompanying drawings in which:

FIG. 1 illustrates a block diagram of a processor-based device in accordance with embodiments of the invention;

FIG. 2 illustrates a perspective view of a processor-based device in accordance with embodiments of the invention;

FIG. 3 illustrates a perspective view of a memory package in an open position in accordance with embodiments of the invention;

FIG. 4 illustrates a partial-sectional, elevation view of a memory package in a closed position in accordance with embodiments of the invention;

FIG. 5 illustrates a perspective view of a memory package housing in accordance with embodiments of the invention;

FIG. 6 illustrates an elevation view of an electronics sub-assembly in accordance with embodiments of the invention; and

FIG. 7 illustrates an exploded view of a circuit board assembly in accordance with embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the verb “couple” or “couples” is intended to mean either an indirect or direct electrical connection. Thus, if a first device couples to a second device, that electrical connection may be through a direct electrical connection, or through an indirect electrical connection via other devices and connections.

### DETAILED DESCRIPTION

The following discussion is directed to various embodiments of the invention. The embodiments disclosed should not be interpreted, or otherwise used, as limiting the scope of the disclosure unless otherwise specified. In addition, one skilled in the art will understand that the following description has broad application, and the discussion of any embodiment is meant only to be exemplary of that embodiment, and not intended to intimate that the scope of the disclosure is limited to that embodiment.

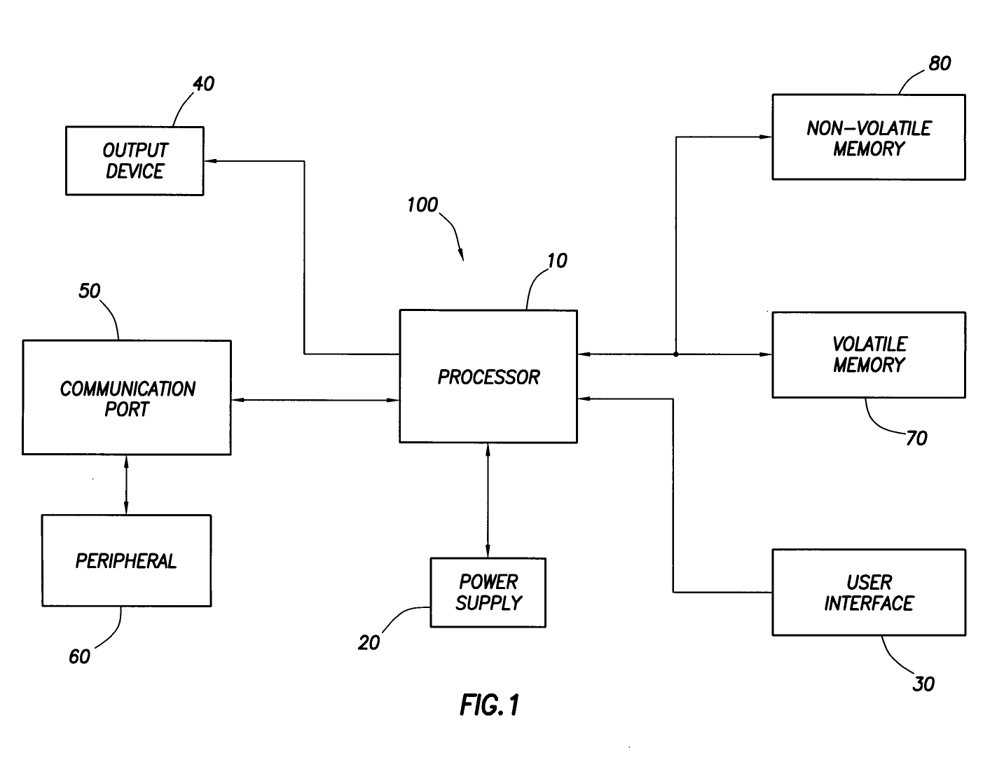

Referring to FIG. 1, a block diagram is illustrated depicting an exemplary computer-based system 100. Computer-based system 100 may be any of a variety of different types, for example a server, a personal organizer, a notebook computer, a personal computer, a workstation, an Internet server, or a minicomputer. In some computer-based systems, a processor may control many of the functions of the system. In the illustrated embodiment, processor 10 controls the functions of computer-based system 100.

Computer-based system 100 may comprise a power supply 20. If system 100 is portable, power supply 20 may comprise permanent batteries, replaceable batteries, and/or rechargeable batteries. Power supply 20 may also comprise an A/C adapter, so that the system may be plugged into a wall outlet, for instance. In fact, power supply 20 may also comprise a DC adapter, so that system 100 may be plugged into the DC voltage supply of a vehicle.

Various other devices may be coupled to processor 10, depending upon the functions that system 100 performs. For example, a user interface 30 may be coupled to processor 10. Examples of user interfaces 30 may comprise buttons, switches, a keyboard, a light pen, a mouse, and/or a voice recognition system. A output device 40 may also be coupled to processor 10. Examples of output devices 40 may comprise: a television screen, a computer monitor, LEDs, or even an audio output device. A communications port 50 may also be coupled to processor 10. Communications port 50 may be coupled to a peripheral device 60, for example a printer, a computer or an external modem.

Processor 10 may utilize programming to control the function of system 100. Memory may be coupled to processor 10 to store and facilitate execution of the programming. For example, processor 10 may be coupled to a volatile memory 70 and a non-volatile memory 80. Non-volatile memory 80 may comprise a read only memory (ROM), for example an EPROM, to be used in conjunction with volatile memory 70. The size of the non-volatile memory 80 may be selected to be sufficient to store any necessary operating system, application programs, and fixed data. Volatile memory 70, on the other hand, may be quite large so that it can store dynamically loaded applications. Alternatively, non-volatile memory 80 may comprise a disk or tape drive memory.

A variety of memory modules, for example DRAMs, SDRAMs, SRAMs can provide the volatile memory 70 to be utilized in conjunction with a given peripheral device or application. The memory modules may be customized for a specific device or be in a standard form widely used in the electronic industry. For example, an SDRAM may be packaged as an industry standard dual inline memory module (DIMM). The present memory package assembly, discussed below, is particularly amenable to employing electric components, for example memory modules, that are utilized in, for example, a server.

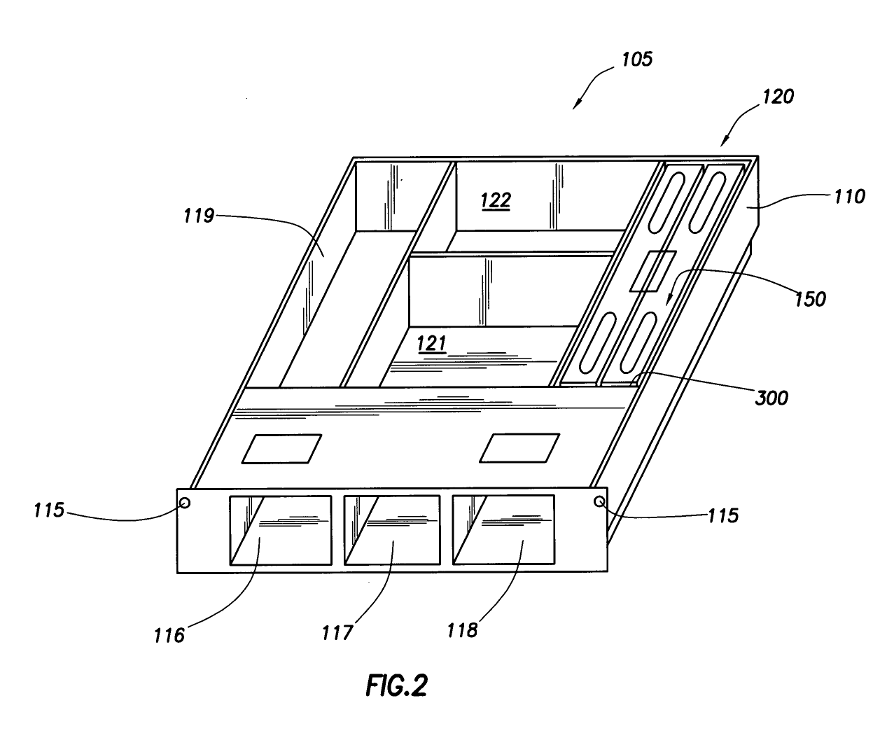

Referring to FIG. 2, an exemplary processor-based device 105 is illustrated. In the embodiments of FIG. 2, processor-based device 105 comprises a chassis 110 configured to house the components of processor-based device 105. Chassis 110 may be secured to a rack, or other securing system (not specifically shown), by, for example, mounting screws 115. Processor-based device 105 may be configured with several modular components that are detachably housed within chassis 110 and enable device 105 to be more easily assembled and repaired. Thus, chassis 110 may comprise separate compartments for accommodating the variety of components, including a power supply compartment 116, hard drive compartment 117, media compartment 118, expansion card compartment 119, memory compartment 120, processor compartment 121, and cooling system compartment 122.

In the illustrated embodiments, memory compartment 120 accommodates a memory package 150 housing a plurality of memory modules, for example DRAMs and SDRAMs. Memory compartment 120 may comprise a receiving slot 300 that provides for the alignment and retention of memory package 150 with the memory compartment. Memory package 150 may be configured so as to allow all of the memory modules for device 105 to be installed or removed simultaneously.

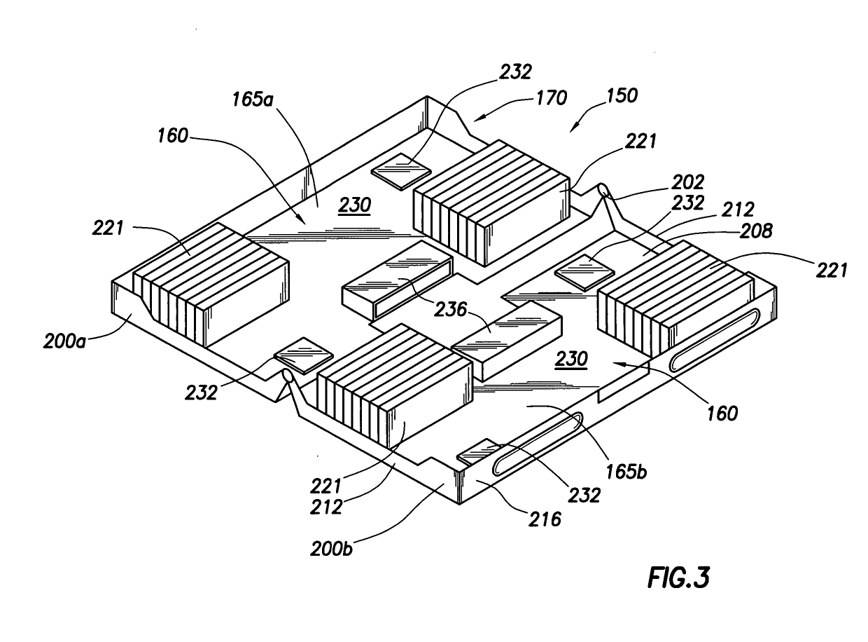

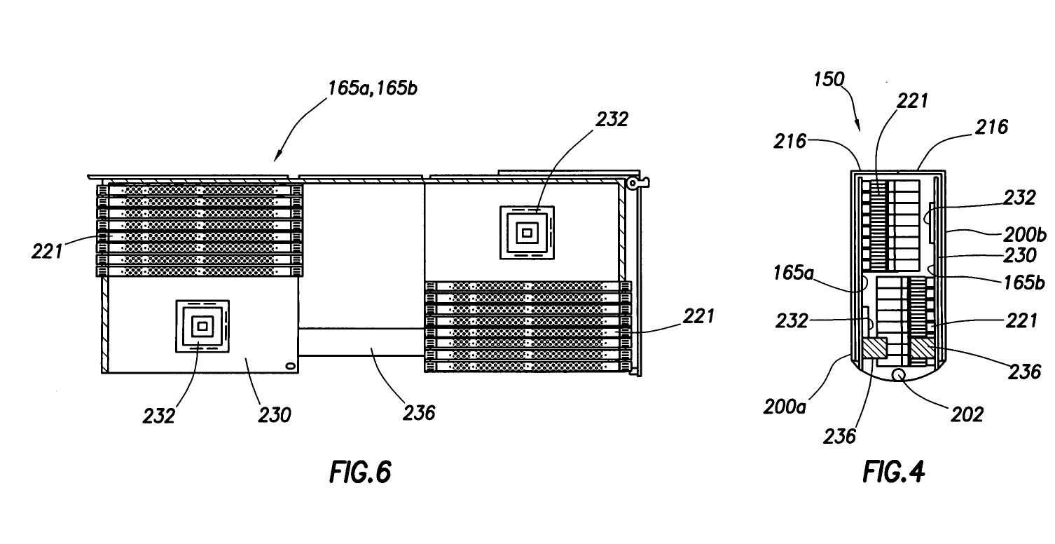

Referring now to FIGS. 3 and 4, an exemplary memory package 150 is shown. Memory package 150 comprises a electronics assembly 160 located at least partially within a housing assembly 170. Housing assembly 170 serves to protect electronics assembly 160 and facilitate the installation and removal of memory package 150 into receiving slot 300 of chassis 110.

An exemplary housing assembly 170 comprises two cover portions 200a and 200b. Both cover portions 200a and 200b may be similarly constructed and comprise a base surface 208, two side surfaces 212, and a closure surface 216. Cover portions 200a and 200b may be connected by hinge 202, or some other mechanism allowing relative movement between the cover portions.

An exemplary electronics assembly 160 comprises two electronic sub-assemblies 165a and 165b. Each electronic sub-assembly 165a, 165b comprises a printed circuit board 230, at least one memory module 221, at least one memory controller chip 232, and at least one electrical connector 236. Printed circuit board 230 couples memory module 221 to memory controller chip 232 and electrical connector 236, which can be coupled to a processor-based device. Therefore, electronics assembly 160 provides the volatile memory 70 for system 100, as shown in FIG. 1. In alternate embodiments, electronics assembly 160 may provide non-volatile memory, expansion cards, or other components suitable for use with processor-based device 105.

Referring to FIG. 3, memory package 150 is shown in an open position where cover portions 200a and 200b are rotated about hinge 202 so as to allow access to electronics assembly 160. In some embodiments, base surfaces 208 of cover portions 200a and 200b, as well as circuit boards 230 of electronic sub-assemblies 165a and 165b, may be substantially parallel to and substantially co-planar with their corresponding components in an open position. The open position provides access to electronic sub-assemblies 165a and 165b for maintenance and service procedures, for example the installation or removal of memory modules 221.

FIG. 4 shows memory package 150 in a closed position configured for assembly into slot 300 of chassis 110, as shown in FIG. 2. Cover portions 200a and 200b are rotated about hinge 202 until closure surfaces 216 contact each other. Printed circuit boards 230 of electronic sub-assemblies 165a and 165b are substantially parallel to and offset from each other allowing the sub-assemblies to nest. In a closed position, the memory modules 221 mounted to the first electronics sub-assembly 165a are adjacent to the memory controller chip 232 mounted to the second electronics sub-assembly 165b. Likewise, the memory modules 221 mounted to the second electronics sub-assembly 165b are adjacent to the memory controller chip 232 mounted to the first electronics sub-assembly 165a. It is in the closed position that memory package 150 interfaces with receiving slot 300 of chassis 110 to allow electronics assembly 160 to be coupled to processor-based device 105, thus facilitating the installation or removal of the plurality of memory modules 221.

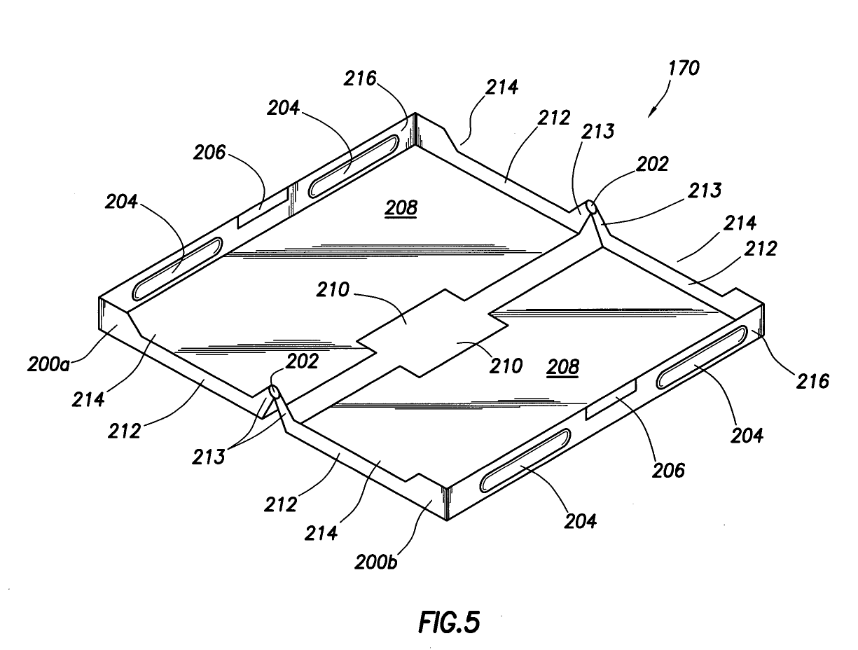

Referring now to FIG. 5, housing assembly 170 is shown without electronics assembly 160. Each cover portion 200a and 200b comprises a base surface 208, two side surfaces 212, and a closure surface 216. In certain embodiments, cover portions 200a and 200b are formed from identical parts or are substantially mirror images of each other.

Base surface 208 may be a substantially rectangular or square shaped surface, having an edge slot 210 therethrough. In certain embodiments, edge slot 210 may be located in the center of the edge of base surface 208 that is opposite from the edge connected to closure surface 216. Edge slot 210 may comprise any shape including, but not limited to, u-shapes and v-shapes. Edge slot 210 serves to provide an opening in memory package 150 so that a piece of equipment located within memory package 150, for example connector 236 of FIG. 6, can be accessed from outside of memory package 150, so that it may be coupled to a processor-based system.

Each side surface 212 may comprise a rhomboidal shape, having a cut-out region 214. Similar to edge slot 210, cut-out region 214 may comprise any shape including, but not limited to, u-shapes and v-shapes. When memory package 150 is closed, cut-out regions 214 serve to provide a vent in memory package 150 so that air circulates to electronics assembly 160, permitting memory package 150 to operate at acceptable temperatures.

Side surfaces 212 may also comprise extended portions 213 that project beyond base surface 208 at angles ranging from 90 to 180 degrees. Extended portions 213 may support hinge 202 that connects the two cover portions 200a and 200b and allows the cover portions 200a and 200b pivotally rotate relative to each other. Hinge 202 may be any mechanism that allows the two cover portions 200a and 200b to move between an open position, for example the position shown in FIG. 3, and a closed position, as shown in FIG. 4. In alternate embodiments, cover portions 200a and 200b may be joined by other attaching structures, for example tabs, clips, screws, and latches. In certain embodiments, cover portions 200a and 200b may be completely disconnected when in the open position.

Closure surfaces 216 are mated when memory package 150 is in a closed position, as shown in FIG. 4. To maintain the closed position, closure surfaces 216 may comprise latch portions 206, which may comprise any suitable structure for securing closure surface 216 of cover portion 200a to closure surface 216 of cover portion 200b. In some embodiments, latch portions 206 may comprise opposing male and female portions, such that the male portion is received by the female portion, thereby securing the two closure surfaces 216 to each other.

In order to facilitate handling of memory package 150, each closure surface 216 may also comprise handling apertures 204. Handling apertures 204 provide a surface for a user to grip memory package 150 and may comprise any shape or size suitable to receive human fingers.

Housing assembly 170 may be partially or wholly constructed of plastic. In some embodiments, cover portions 200 are constructed of plastic so that when a user installs or removes memory package 150 from chassis 110, the user is electrically insulated from electronics assembly 160. Housing assembly 170 may also act as a thermal insulator to reduce exposure to the potentially high temperatures caused by the electronics assembly 160 within housing assembly 170.

Referring now to FIG. 6, an exemplary electronics sub-assembly 165a or 165b is shown comprising printed circuit board 230, memory modules 221, memory controller chips 232, and electrical connector 236. Certain embodiments may comprise a greater or lesser quantity of each component than is shown in FIG. 6. In some embodiments, memory modules 221, e.g., DIMMs, are grouped in collections of eight. In certain embodiments, electronic sub-assemblies 165a and 165b, as shown in FIG. 2, may be identical to, or mirror images of, each other. Memory controller chips 232 serve to control the transfer of data to and from the memory modules 221. The proximate placement of memory controller chips 232 to memory modules 221, aids to minimize the distance an electrical signal must travel between controller chips 232 and memory modules 221. As the distance the signal must travel decreases, the speed with which memory modules 221 can be accessed increases.

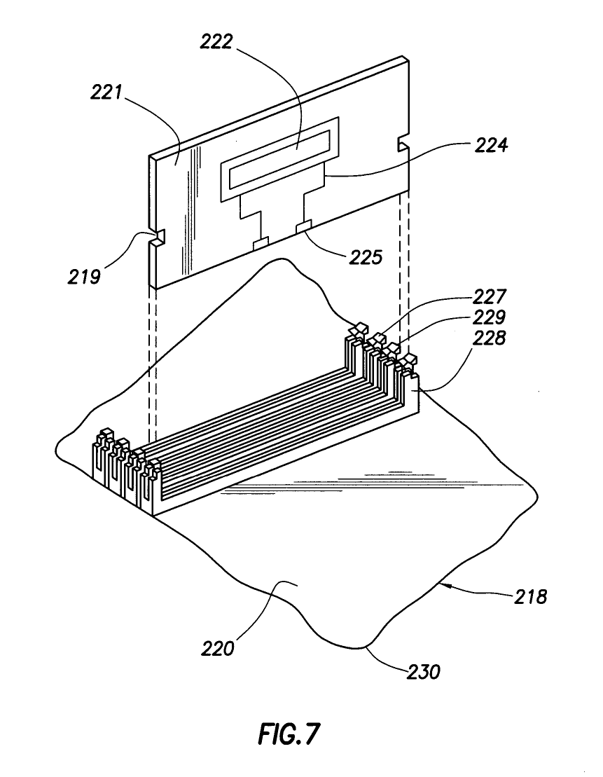

The connection of memory modules 221 to printed circuit board 230 is illustrated in greater detail in FIG. 7 where printed circuit board 230 comprises an upper surface 220 including sockets 228 for accepting memory modules 221. Each socket 228 comprises edge clips 227 with releases 229 for mounting and securing the memory modules 221 in the sockets. Printed circuit board 230 also comprises a lower surface 218 which attaches to a base surface 208 of a cover portion 200a or 200b, as shown in FIG. 3. Conductive traces 224 on module 221 electrically couple memory element 222 to edge connectors 225 along an edge of module 221. Additionally, module 221 may be manufactured with small notches 219 in opposite edges in order to interface with clips 227 and hold module 221 securely within socket 228.

As shown in FIG. 6, printed circuit board 230 also comprises electrical connector 236, which is electrically coupleable to a corresponding multi-pin connector (not shown) disposed within a processor-based device, for example device 105 of FIG. 2. Printed circuit board 230 couples memory modules 221 to memory controller chips 232 and electrical connector 236. Thus, when connector 236 is coupled to the corresponding multi-pin connectors of processor-based device 105, a conductive path from memory module 221 to processor-based device 105 is completed.

Once memory modules 221 are coupled to printed circuit board 230, memory package 150 can be closed by rotating cover portions 200a and 200b toward each other and into a closed position such that the electronic sub-assemblies 165a and 165b nest with each other, as shown in FIG. 4. As shown in FIG. 2, the closed memory package 150 can then be installed in processor-based device 105 by inserting the package into a suitable receiving slot 300 in chassis 110 (FIG. 2). In some embodiments, external guides (not shown) may align memory package 150 along corresponding guides (not shown) within receiving slot 300.

Once memory package 150 is placed within receiving slot 300, electrical connectors 236 of memory package 150 engage with the respective multi-pin connectors disposed within processor-based device 105. Memory package 150 may likewise be removed by lifting memory package 150 and disengaging connectors 236 from processor-based device 105. The force required to install and remove memory package 150 may be manual force applied by a user, for example through handling apertures 204, or may be applied through a mechanism integrated with or assembled to chassis 110 or memory package 150.

In some embodiments, the two cover portions 200a and 200b and the two electronics sub-assemblies 165a and 165b are constructed from identical or substantially similar components. For example, in the embodiment shown in FIG. 3, each electronics sub-assembly 165a and 165b comprises an identical printed circuit board 230. The two printed circuit boards 230 are configured within housing assembly 170 as mirror images of each other, so as to allow nesting of the electronics sub-assemblies 165a and 165b, as shown in FIG. 4. The nesting feature reduces the overall footprint of memory package 150, thus allowing a greater number of components to be utilized in a given volume, e.g., more memory modules can be used or the same number of memory modules can be housed in a reduced volume. The duplication of identical or substantially similar components also reduces fabrication and production costs by reducing the number of different components found in a given assembly.

The above discussion is meant to be illustrative of the principles and various embodiments of the present invention. Numerous variations and modifications will become apparent to those skilled in the art once the above disclosure is fully appreciated. For example, memory package 150 may further comprise a sensor (not shown), which enables user to determine if memory package 150 is electrically connected to processor-based device 105. Furthermore, the principles of the present invention could easily be configured for use in a desktop or other non-portable computer system. Finally, the use of the memory module and/or memory package may find application well outside the embodiments described in this specification, and thus the specification should not be construed as limited only to personal computer systems. It is intended that the following claims be interpreted to embrace all such variations and modifications.

1. A memory package comprising:
a first cover portion;
a first electronics sub-assembly that comprises a circuit board with at least one memory module socket and at least one controller chip, wherein said first electronics assembly is supported by said first cover portion;
a second cover portion connected to said first cover portion; and
a second electronics sub-assembly that comprises a circuit board with at least one memory module socket and at least one controller chip, wherein said second electronics assembly is supported by said second cover portion; wherein
said first and second cover portions are moveable between a closed position wherein said electronics sub-assemblies are nested.

2. The memory package of claim 1 wherein each of said first and second cover portions further comprises a base surface; and wherein when said cover portions are in the closed position, the base surfaces of said cover portions face each other.

3. The memory package of claim 1 wherein the circuit boards of said first and second electronics sub-assemblies are positioned substantially parallel to and offset from each other when said first and second cover portions are in the closed position.

4. The memory package of claim 1 wherein, when said first and second cover portions are in the closed position, the memory module sockets mounted to said first circuit board are adjacent to the controller chip mounted to the second circuit board and the memory module sockets mounted to the second circuit board are adjacent to the controller chip of the first circuit board.

5. The memory package of claim 1 wherein each of said first and second cover portions further comprises a base surface; and wherein when said cover portions have an open position wherein the base surfaces of said cover portions do not face each other.

6. The memory package of claim 5 wherein the circuit boards of said first and second electronics sub-assemblies are positioned substantially parallel to and substantially co-planar with each other when said first and second cover portions are in the open position.

7. The memory package of claim 1 further comprising a hinge pivotally connecting said first cover portion and said second cover portion.

8. The memory package of claim 1 further comprising a latch operable to retain said cover portions in the closed position.

9. The memory package of claim 1 wherein further comprising an electrical connector operable to couple said electronic sub-assemblies to a processor-based device.

10. The memory package of claim 1 wherein each electronic sub-assembly further comprises an electrical connector operable to couple one electronic sub-assembly to a processor-based device.

11. The memory package of claim 1 further comprising a handling aperture in at least one of said cover portions.

12. The memory package of claim 1 wherein the circuit board of said first electronics assembly is identical to the circuit board of said second electronics assembly.

13. The memory package of claim 1 further comprising a plurality of memory modules received by the memory module sockets.

14. A computer system comprising:
a processor;
a chassis supporting said processor; and
a memory package comprising;
an electronics assembly comprising first and second circuit boards, wherein each circuit board is coupled to at least one memory module and at least one memory controller; and
a housing assembly supporting said electronics assembly, wherein said housing assembly has a first cover portion supporting the first circuit board and a second cover portion supporting the second circuit board;
wherein said memory package has a closed position and an open position, wherein in the closed position said housing engages said chassis and said electronics assembly electrically couples with said processor.

15. The computer system of claim 14 wherein the first and second circuit boards are positioned substantially parallel to and offset from each other when said memory package is in the closed position.

16. The computer system of claim 15 wherein when said memory package is in the closed position, the memory modules mounted to said first circuit board are adjacent to the memory controller mounted to the second circuit board and the memory modules mounted to the second circuit board are adjacent to the memory controller mounted to the first circuit board.

17. The computer system of claim 14 wherein said memory package has an open position wherein said housing is disengaged from said chassis and said electronics assembly is decoupled from said processor.

18. The computer system of claim 17 wherein the first and second circuit boards are positioned substantially parallel to and substantially co-planar with each other when said memory package is in the closed position.

19. The computer system of claim 14 wherein the electronics assembly further comprises at least one electrical connector coupled to the first and second circuit boards, wherein the at least one electrical connector couples the electronics assembly to said processor.

20. The computer system of claim 14 wherein the housing assembly further comprises a hinge pivotally connecting the first cover portion and the second cover portion.

21. The computer system of claim 14 wherein the housing assembly further comprises a latch operable to retain said cover portions in the closed position.

22. A memory package comprising:
means for housing a first and second electronics sub-assemblies, wherein each sub-assembly has at least one memory module and at least one memory controller chip mounted thereto;
means for moving at least a portion of said means for housing between an open position allowing access to the memory modules and a closed position where the two electronics sub-assemblies are nested together.

23. The memory package of claim 22 further comprising means for coupling the first and second electronics sub-assemblies to a processor-based device when said means for housing is in the closed position.

24. The memory package of claim 22 further comprising means for retaining said means for housing in the closed position.
